(19) United States
(12) Patent Application Publication
(10) Pub. No.: US 2011/0043348 A1
(43) Pub. Date: Feb. 24, 2011

(54) Shift Prompt System

(76) Inventors: Michael Blackard, Jamestown, NC (US); Subramanian Arumugam, Jamestown, NC (US)

Correspondence Address: POTOMAC PATENT GROUP PLLC, P. O. BOX 270, FREDERICKSBURG, VA, 22404, US

(21) Appl. No.: 12/544,489

(22) Filed: Aug. 20, 2009

(51) Int. Cl. B60Q 1/00

(52) U.S. Cl. 340/439

(57) ABSTRACT

A method for providing guidance in shifting gears of vehicle includes obtaining data from a plurality of vehicle sensor, determining at least one shifting range based on the obtained data, the shifting range being represented by an engine speed, and displaying the shifting range to an operator of the vehicle

### BACKGROUND

This invention relates to trucks and more particularly, to systems that facilitate efficient operation of trucks by providing guidance to the drivers in shifting gears.

Large trucks typically have a manual transmission requiring the operators (or drivers) to be able to shift gears. Inexperienced operators do not shift the gears properly. This may stem from their inexperience in driving trucks or from their inexperience with a new or a different truck for example. There are multiple types of transmissions and drive trains each potentially having a different shift point. Therefore, even drivers having experience with one truck have to become familiar with a different type of truck before they are able to shift properly.

Improper shifting could damage or shorten the expected lifecycle of the transmission. This could lead to an increased maintenance or expensive repairs. Both of these result in a downtime in the utilization of the vehicle. Improper shifting also affects the fuel economy of a truck. This is particularly important to owners of large fleets. A slight increase in the fuel economy in each truck can have significant cumulative savings for the fleet.

An existing system that provides assistance to drivers with shifting is the Gear Master which is an add-on device that can be connected to a data port on the truck for monitoring engine speed (rpm) and vehicle speed. However, the shift points for a vehicle have to be trained or manually programmed into the Gear Master while the vehicle is in motion. Gear Master is not integrated with the vehicle and does not know the vehicle gear.

### SUMMARY

In one embodiment, a method for providing guidance in shifting gears of vehicle comprises: obtaining data from a plurality of vehicle sensor; determining at least one shifting range based on the obtained data, the shifting range being represented by an engine speed; and displaying the shifting range to an operator of the vehicle.

In another embodiment, a gear shift guidance system comprises: a processor for determining at least one shifting range based on data obtained from a plurality of vehicle sensors; and a display for displaying the determined shifting range wherein the shifting range represents an engine speed range.

### BRIEF DESCRIPTION OF THE DRAWINGS

The several features, objects, and advantages of Applicants' invention will be understood by reading this description in conjunction with the drawings, in which:

FIG. 1 illustrates an exemplary tachometer;

FIG. 2 illustrates a tachometer with shifting ranges according to exemplary embodiments;

FIG. 3 illustrates a display providing shifting guidance according to exemplary embodiments;

FIG. 4 illustrates a tachometer with optimal and permissible shifting ranges according to exemplary embodiments;

FIG. 5 illustrates a tachometer with optimal, permissible and prohibited ranges according to exemplary embodiments;

FIG. 6 illustrates a display providing shifting guidance according to exemplary embodiments;

FIG. 7 illustrates a method in accordance with exemplary embodiments; and

FIG. 8 illustrates a system in accordance with exemplary embodiments.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

According to exemplary embodiments, a shift prompt system is disclosed. The exemplary shift prompt system may provide guidance to an operator of a vehicle in shifting gears of the vehicle. The guidance may be in the form of a visual indication on the tachometer gauge for example. In alternative embodiments, the guidance may also be provided via an audio means or via an audio means in combination with a visual indication.

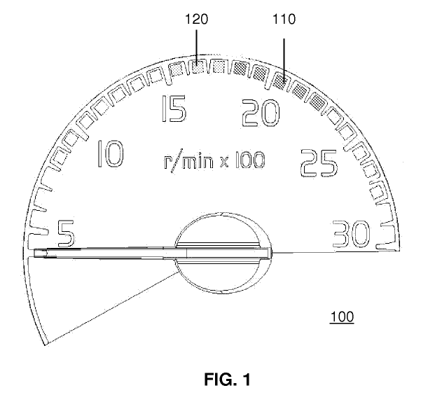

Exemplary embodiments provide visual guidance through the use of light emitting diodes (LEDs) which may be implemented within a gauge. An exemplary gauge is illustrated in FIG. 1. Gauge 100 may be a tachometer. An LED may be associated with each 100 rpm increment such as 1400 rpm, 1500 rpm, etc. LED 110 may indicate 2000 rpm and LED 120 may indicate 1600 rpm for example.

While the vehicle in motion, the vehicle operator may be provided with an indication of an optimal engine speed (i.e. engine rpm) for shifting the transmission into the next available or next appropriate gear. The transmission may be shifted into a higher gear (i.e. upshift) or into a lower gear (i.e. downshift). Higher gear may be appropriate as a truck increases speed and a lower gear may be appropriate with decreased speed.

Data from various components of the vehicle may be monitored or used to determine a proper shifting range. A component could be an electronic device or a sensor. The data may include, but not limited to, road and engine speeds. The data may be obtained from one or more of the brake, clutch, accelerator, transmission range sensor, transmission gear split sensor, transmission gear position sensor, transmission gearing, rear axle ratio, etc.

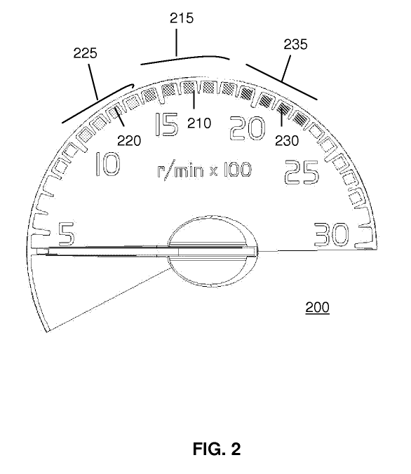

An appropriate shifting range may be indicated via the illumination of LEDs 210, 220 and 230 as illustrated in FIG. 2. Multiple ranges 215, 225 and 235 may be illuminated on gauge (or tachometer) 200. A first range 215 may correspond to an optimal shifting range for example. A second range 225 may correspond to an acceptable or permissible shifting range (but not the optimal shifting range) for example. A third range 235 may correspond to a prohibited shifting range for example. The prohibition may be due to potential damage to the engine for example. The third range could alternatively be a permitted, but not recommended, shifting range. Both the second and third shifting ranges may also indicate, for example, lowered fuel economy if the shift occurs in this range.

The first range 215 may be indicated by LEDs 210 that may be illuminated by a first color, such as green for example (illustrated with medium shading in FIG. 2). The second range 225 may be indicated by LEDs 220 that may be illuminated by a second color, such as yellow for example (illustrated with light shading in FIG. 2). The third range 235 may be indicated by LEDs 230 that may be illuminated by a third color, such as red for example (illustrated with dark shading in FIG. 2). The colors described herein are purely for illustrative purposes and are not intended to be limiting.

As illustrated in FIG. 2, an exemplary system may determine that the first range (i.e. optimal range) 215 is between 1400 rpm to 1900 rpm and may be indicated by illuminated or flashing LEDs 210 that are green. The second range 225 may be determined to be between 1000 rpm and 1400 rpm which may be indicated by illuminated or flashing LEDs 220 that are yellow. The third range 235 may be determined to be between 1900 rpm and 2300 rpm which may be indicated by illuminated or flashing LEDs 230 that are red.

A single LED may be illuminated in different colors (i.e. the first color, the second color or the third color) at different times. Alternatively, separate colored LEDs may also be illuminated. The colors may include red, green and yellow.

In some embodiments, tricolor LEDs may be utilized. The three colors in a tricolor LED typically consist of red, green and blue. Blue may be substituted for yellow in indicating the permissible (though not optimal) shifting range in this embodiment.

The number of colors may also be increased to four to include blue (in addition to red, green and yellow). A tricolor LED may be utilized in combination with a yellow LED. The blue color in the tricolor LED may be used to indicate the prime shifting point within the optimal shifting range that is indicated by green (i.e. the blue point may be surrounded by the green range and/or the blue point may be in the center of the green range).

A tricolor LED may obviate the need for multiple (i.e. three) LEDs at each 100 rpm indication; even the tricolor LED combined with a yellow LED would still only involve using two (as opposed to four) LEDs.

The LEDs in the various ranges may be illuminated constantly or in a flashing manner until the shift occurs. When (or if) the engine rpm value reaches the first shifting range 215 (i.e. optimal shifting range or green for example), the second shifting range 225 (i.e. permissive shifting range or yellow for example) may no longer need to be illuminated in gauge 200 by LEDs 220. Only the first and third shifting ranges 215 and 235 (i.e. green and red or optimal and prohibited shifting ranges for example) may be illuminated by LEDs 210 and 230 on gauge 200. In some embodiments, only the optimal shifting range 215 may be displayed or illuminated by LEDs 210 on gauge 200.

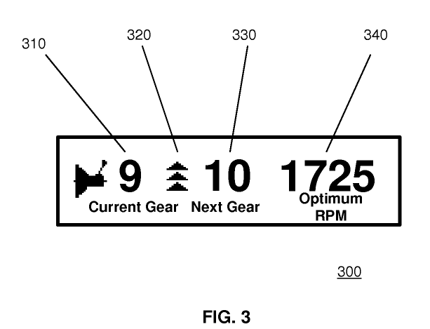

In addition to (or in place of) gauge 200, a display may provide the shift guidance information. An exemplary display 300 is illustrated in FIG. 3. Display 300 may display a current gear 310, a next gear 330, the proposed direction of the shift (up in this example) 320 and a prime shifting point 340 (referred to as the optimum RPM in FIG. 3). The gear can be shifted up once the engine rpm value reaches the prime shifting point 340. Display 300 may be located within the dashboard of a truck.

In an upshift situation (as the vehicle road speed increases for example), data from one or more of the components or sensors listed above may be used to determine the shifting point. The shifting point can be an engine speed (rpm) range or can be a particular value (i.e. the prime shifting point described above). The three ranges 215, 225 and 235 discussed above may be indicated on gauge 200 of FIG. 2. The prime shifting point 340 may be indicated in display 300 of FIG. 3 or it could also be indicated within the optimal shifting range 225 of FIG. 2.

In a downshift situation (i.e. as the vehicle is slowing down for example), data from one or more of the components as listed above may be used to determine the shifting point. The process for determining a downshift may be commenced by the depression of the brake or 0% throttle. This could be any action that would cause a decrease in the road speed. A downshift could also occur when the vehicle is going uphill and the vehicle loses momentum (i.e., vehicle speed) so a downshift would be needed.

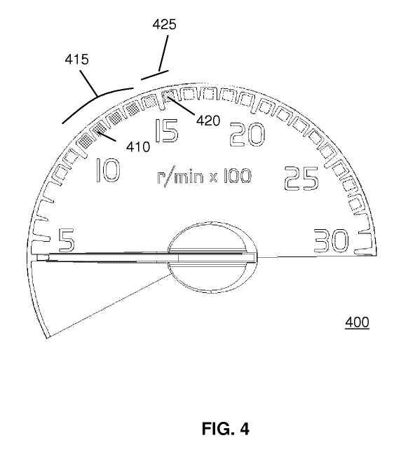

A downshift situation may include a two step process for an unsynchronized transmission (e.g. the “double clutching” process). The transmission has to be taken out of gear first. Exemplary shifting ranges for taking the transmission out of gear are illustrated in FIG. 4. Gauge 400 indicates the optimal and permissible shifting ranges 415 and 425 where the transmission can be taken out of gear. In this example, the optimal shifting range 415 (between 1000 and 1400 rpm) may be illuminated by LEDs 410 and the permissible shifting range 425 (between 1400 and 1600 rpm) may be illuminated by LEDs 420.

While not illustrated, a prohibited shifting range could also be indicated in gauge 400 for taking the transmission out of gear. Alternatively, gauge 400 could indicate the optimal shifting range 415 (without indicating the other shifting ranges) or could also include the prime shifting point (in addition or in place of the optimal shifting range) with a blue LED as described above.

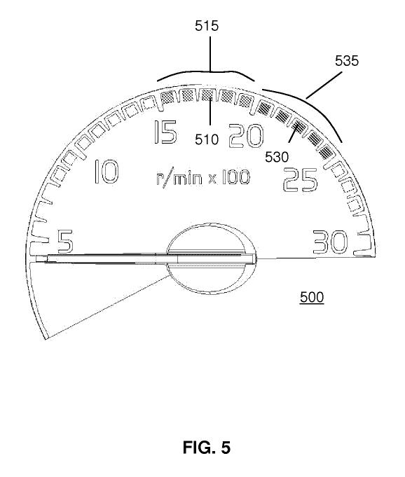

The next step for an unsynchronized transmission would be to engage the lower gear. This could be accomplished by increasing the engine speed (i.e. increase the rpm) and then shifting into the lower gear. Exemplary shifting ranges for engaging or shifting into the lower gear are illustrated in FIG. 5. Gauge 500 indicates the optimal and prohibited shifting ranges 515 and 535 respectively. The optimal range 515 (between 1500 and 2000 rpm) may be illuminated by LEDs 510 and the prohibited range 535 (between 2000 and 2500 rpm) may be illuminated by LEDs 530.

In a downshift, the engine speed may be increased (after taking out of the higher gear) in order to engage the lower gear. The shifting range (optimal range for example) for taking the transmission out of the current gear is typically lower than the shifting range for engaging the transmission into the lower gear. The optimal shifting range for shifting out of (the higher) gear may not overlap the optimal shifting range for engaging the lower gear in some embodiments. In other embodiments, there may be an overlap between these shifting ranges.

While not illustrated, a permissible shifting range could also be indicated in gauge 500 for engaging the lower gear. Alternatively, gauge 500 could indicate the optimal shifting range 515 (without indicating the other shifting ranges) or could also include the prime shifting point with a blue LED as described above.

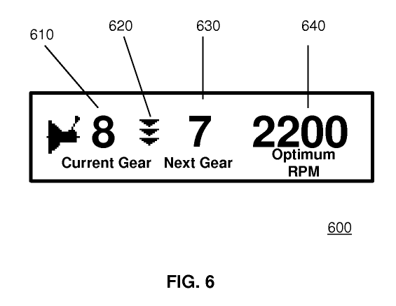

An exemplary downshift information may also be displayed as illustrated in FIG. 6. Display 600 includes current gear 610, next gear 630, the proposed direction of the shift (down in this example) 620 and a prime (down) shifting point 640. The gear can be shifted down once the engine RPM value reaches the prime shifting point 540.

As described above, data from various components of the vehicle may be monitored or used to determine a proper shifting range. Sensors may be added to a gear shifter, splitter and range selector to detect the current gear. While the vehicle is in operation, each of the following may be monitored: road speed, engine speed, current gear, clutch status, throttle position, brake pedal, etc. The shifting points and ranges may be determined based on the monitored values as well as on internal algorithms and tables.

According to one embodiment, the system illuminates the LEDs only when a shift is determined to be needed. For example, when the engine speed is increasing and the vehicle speed is increasing, an up shift is indicated and the appropriate ranges will be illuminated. As another example, if the vehicle speed is decreasing and the engine speed is increasing (as in climbing a hill in a high gear), a downshift is indicated and the appropriate ranges will be illuminated. If the vehicle is cruising, that is, the engine speed and vehicle speed are relatively constant, the display will not be illuminated.

In another exemplary embodiment, if the truck road speed is increasing and the engine speed is decreasing (as in going downhill), a downshift is indicated for maintaining control of the truck and the appropriate ranges will be illuminated.

Trucks are equipped with an electronic stability protection (ESP) system for maintaining stability of the cab portion. This system can detect a gradient of the truck to determine if it is traveling downhill or uphill. A GPS system can also be used to detect whether a vehicle is traveling uphill or downhill. The GPS may compare altitude of the vehicle at periodic intervals (such as every five seconds for example) to determine whether the vehicle is traveling uphill or downhill. In some embodiments, the gradient determination may be utilized to indicate appropriate shifting of gears.

The actuation of a brake may be detected to indicate that the vehicle is slowing down and the appropriate engine speed ranges for shifting the gears can be illuminated. The current gear can be determined by a gear position sensor. This information may be used to determine the next gear and indicated in the display.

In some embodiments, a warning can be provided to prevent unnecessary shifting of gears. An operator may attempt to shift the gear when no changes in the driving conditions are encountered. The data from the various sensors highlighted above may not indicate a need for shifting the gear. In this scenario, a prohibited range may be illuminated in the tachometer centering on the current engine speed indication or the entire engine speed range may be illuminated. In addition, an audio warning may also be provided. The audio warning may be in the form of a voice or a series of electronic beeps for example.

Data from clutch and brake pedal may be received via J1939 or J1587 interface or by hardwired inputs. The accelerator data may be received via J1939 or J1587 interface. The shift points may be determined based on transmission gearing, rear axle ratio and tire configurations for example. The various shifting ranges and shift points for each vehicle condition (as monitored by the sensors or components for example) may be pre-programmed for each different type of engine.

A selected gear could also be estimated based on the engine speed and road speed. The displayed parameters in display 300 or 600 in FIGS. 3 and 6 need not be limited to what is illustrated—road speed and/or engine speed could also be displayed for example.

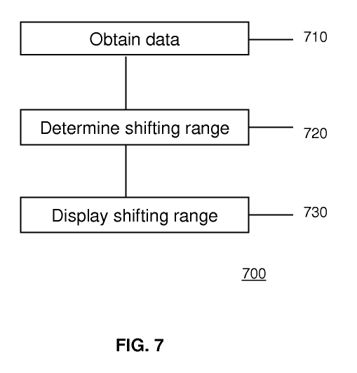

A method in accordance with exemplary embodiments for providing guidance in shifting gears of a vehicle is illustrated in FIG. 7. Data may be obtained form, for example a plurality of vehicle sensors at 710. At least one shifting range may be determined from the obtained data 720. The range may be the optimal shifting range as described above for example. Other shifting ranges (i.e. the permissible shifting range and the prohibited shifting range may also be determined. The at least one shifting range (corresponding to the optimal shifting range for example) may be displayed to an operator at 730. The other shifting ranges (i.e. permissible shifting range and prohibited shifting range) may also be displayed to the operator or driver.

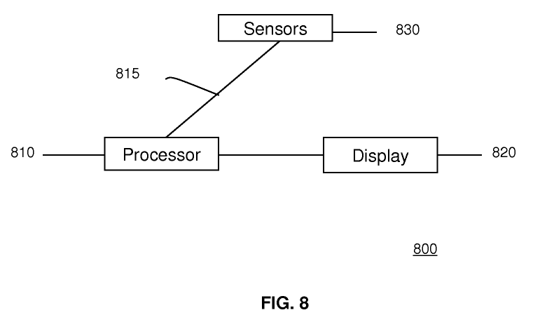

A system in accordance with exemplary embodiments is illustrated in FIG. 8. Guidance system 800 may include processor 810 and display 820. Processor 810 may be an existing processor within the instrument cluster of a truck for example. Processor 810 may receive inputs from various vehicle sensors 830 over a data interface 815. Sensors 830 may include separate components—they are illustrated as a single component for simplicity and are not intended to be limited to a single object or sensor. Processor 810 may then determine the shifting ranges based on input values from the various sensors and comparing these input values with pre-programmed data. The corresponding ranges may be displayed on display 820 which can be the tachometer or a separate display in the dashboard of the truck as described above.

Exemplary embodiments as described above may also facilitate skipping gears. That is, a shifting of gears need not be limited to shifting into the next gear. In an up shift situation, if the vehicle is going down hill for example, the vehicle picks up speed which makes it possible to skip a gear. In a down shift situation, after the gear has been disengaged, if the vehicle slows down to a particular speed, a gear can be skipped.

The system as described may also be implemented in an engine that can be operated in a performance mode and a fuel economy mode. Performance mode is typically associated with higher load conditions (increased weight on the trailer portion of the truck) or based on road conditions. In this mode, the shifting ranges are higher. In a fuel economy mode, where the overall goal might be to sacrifice some performance for increased fuel economy, the shifting ranges are lower. The mode will typically be set at the factory according to customer order. Alternatively, a mode setting function may be provided wherein an owner of the vehicle can select and change between fuel economy mode and performance mode.

It will be appreciated that the procedures (arrangement) described above may be carried out repetitively as necessary to perform vehicle maintenance. To facilitate understanding, many aspects of the invention are described in terms of sequences of actions. It will be recognized that the various actions could be performed by a combination of specialized circuits and mechanical elements.

The invention is not limited to implementation in large vehicles such as trucks; it could be implemented in any vehicle utilizing a manual shift transmission, including cars, SUVs, minivans, etc. In addition, the invention is not limited to utilizing a J1939 and J1587. Other protocols for communicating vehicle data may also be used. Furthermore, the shifting ranges or points (such as the various ranges or prime shifting point described above) could also be announced via an audio means such as a voice. An audio tone could also be used to indicate an optimum shifting range or prime shifting point; that is, when the vehicle is operating in the optimum shifting range, an audio tone or voice could be used to indicate that the current engine speed is optimum for shifting gears. The proposed shift direction (i.e. up or down) as well as the next gear could also be announced. One type of audio tone may be used to indicate an up shift and another for a down shift.

Thus, the invention may be embodied in many different forms, not all of which are described above, and all such forms are contemplated to be within the scope of the invention. It is emphasized that the terms “comprises” and “comprising”, when used in this application, specify the presence of stated features, steps, or components and do not preclude the presence or addition of one or more other features, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method for providing guidance in shifting gears of a vehicle, the method comprising the steps of:
obtaining data from a plurality of vehicle sensors;
determining at least one shifting range based on the obtained data, the shifting range being represented by an engine speed of the vehicle; and
displaying the shifting range to an operator of the vehicle.

2. The method of claim 1, further comprising determining a plurality of non-overlapping shifting ranges wherein the plurality includes at least one of an optimal shifting range, a permissible shifting range and a prohibited shifting range.

3. The method of claim 2, wherein displaying the shifting ranges comprises illuminating the shifting ranges on a tachometer of the vehicle.

4. The method of claim 3, wherein each shifting range is illuminated in a different color.

5. The method of claim 4, wherein the illumination is via a plurality of light emitting diodes (LEDs).

6. The method of claim 2, further comprising determining a prime shifting point within the optimal shifting range.

7. The method of claim 6, further comprising displaying the prime shifting point and optimal shifting range with illumination, the prime shifting point being displayed using a color different than a color used for displaying the optimal shifting range.

8. The method of claim 7, further comprising displaying the prime shifting point at a center of the optimal shifting range.

9. The method of claim 6, wherein displaying the shifting range comprises displaying a current gear of the vehicle, a direction of shift, the prime shifting point and a proposed new gear.

10. The method of claim 2, wherein in the event of a down shift, the method further comprises:
displaying a first set of shifting ranges for shifting a transmission of the vehicle out of a current gear; and
displaying a second set of shifting ranges for shifting the transmission into a next gear.

11. The method of claim 10, wherein an optimal shifting range within the first set of shifting ranges is lower than an optimal shifting range within the second set of shifting ranges.

12. A gear shift guidance system for a vehicle comprising:
a processor for determining at least one shifting range based on data obtained from a plurality of vehicle sensors; and
a display for displaying the determined shifting range wherein the shifting range represents an engine speed range.

13. The gear shift guidance system of claim 12, wherein the shifting range corresponds to an optimal shifting range for shifting a current gear of a vehicle.

14. The gear shift guidance system of claim 12, wherein the processor is programmed to determine a plurality of shifting ranges.

15. The gear shift guidance system of claim 14, wherein the shifting ranges correspond to an optimal shifting range and a permissible shifting range.

16. The gear shift guidance system of claim 12, wherein the processor is configured to determine a prime shifting point within the optimal shifting range.

17. The gear shift guidance system of claim 12, wherein the vehicle sensors include at least one of: road speed, engine speed, current gear, clutch status, throttle position, brake pedal.

18. The gear shift guidance system of claim 12, wherein the processor determines two shifting ranges in a down shift situation, the first range for shifting a transmission out of a current gear and the second range for shifting the transmission into a lower gear.

19. The gear shift guidance system of claim 12, wherein the display for displaying the determined shifting range is integrated with a tachometer of the vehicle.

20. The gear shift guidance system of claim 19, wherein the display for displaying the shifting range includes light emitting diodes (LEDs).
